(19) United States
(12) Patent Application Publication
(10) Pub. No.: US 2008/0235184 A1
(43) Pub. Date: Sep. 25, 2008

(54) Image Search Method, Image Search Apparatus, and Recording Medium Having Image Search Program Code Thereon

(75) Inventor: Takeshi Nakamura, Saitama (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION, Tokyo (JP)

(21) Appl. No.: 11/547,082

(22) PCT Filed: Mar. 22, 2005
(86) PCT No.: PCT/JP05/05649

§ 371 Date: Nov. 14, 2006

(30) Foreign Application Priority Data
Mar. 31, 2004 (JP) 2004-106037

(51) Int. Cl. G06F 17/30

(52) U.S. Cl. 707/3; 707/E17.014

(57) ABSTRACT

Disclosed is an image search apparatus capable of efficiently and conveniently searching a large number of images accumulated in a storage device such as HDD for an image desired by the user. This image search apparatus comprises a storage device for accumulating a plurality of images to be searched; a feature acquisition unit for at least one component from each of a plurality of images to be searched, the at least one component being common to the plurality of images to be searched, and for deriving a feature which characterizes each of the images to be searched based on the at least one component; a network generator for calculating similarity measures among the plurality of images to be searched using the feature, and associating images that have the similarity measures within a predetermined range, with one another through links; and an image search unit for calculating a display link distance between two images to be searched that are associated with each other through N links (where N is an integer equal to or larger than one), so as to set the display link distance between the two images to N, and for searching the plurality of images.

### TECHNICAL FIELD

The present invention relates to techniques for searching a large number of images stored in a storage device such as an HDD (hard disk drive) for a desired image.

### BACKGROUND ART

In order to efficiently search a large number of still images or moving images accumulated in a large capacity storage device such as an HDD for an image desired by a user, various image search methods have been conventionally proposed. This type of method commonly extracts features such as temporal information, color information and the like from each of the large number of images to be searched, calculates similarity measures among the images based on the features, and associates the images with one another on the basis of the similarity measures to generate a database.

For example, an information search method described in Patent Document 1 (Japanese Patent Application Kokai No. 9-259130) employs a method which lays out a large number of information pieces to be searched in a two-dimensional or three-dimensional hierarchical space, and displays these information pieces to be searched in three-dimensions. Specifically, features such as colors, shapes, sizes, types, contents, keywords or the like of images to be searched are extracted for each of information pieces to be searched. Feature vectors are then generated on the basis of the features, and the similarity measures among information pieces to be searched are calculated on the basis of the feature vectors. Many information pieces to be searched are laid out in a search space such that a distance between information pieces is closer as the similarity measure is higher, to constitute a first search layer. Several information pieces to be searched are extracted from the first search layer to constitute a second search layer of one hierarchical step higher than the first search layer. Several information pieces to be searched are then extracted from the second search layer to constitute a third search layer of one hierarchical higher than the second search layer. By recursively performing such an extraction process for information pieces to be searched, the first to n-th search layers (where n is an integer equal to or larger than two) can be constituted. When the user searches information, the first to n-th search layers are displayed in three-dimensions.

Furthermore, an image search method described in Patent Document 2 (Japanese Patent Application Kokai No. 11-175535) calculates a multidimensional vector space by statistically processing features of images. The image search method further selects one axis, two axes or three axes from the multidimensional vector space, projects reduced sized images of the images on a coordinate space given by the selected one, two or three axes, and displays the result.

In the conventional image search methods, search processing cannot sufficiently utilize features of images to be searched. There is a growing consumer demand for an image search system to efficiently and conveniently search.

### DISCLOSURE OF THE INVENTION

In view of the foregoing aspects and the like, it is a main object of the present invention to provide an image search method, image search apparatus, and recording medium having an image search program code thereon which enable a user to efficiently and conveniently search for a desired image in a large number of images accumulated in a storage device such as an HDD.

According to a first aspect of the present invention, there is provided an image search method comprising the steps of: (a) extracting at least one component from each of a plurality of images to be searched, said at least one component being common to the plurality of images to be searched; (b) deriving a feature which characterizes each of the images to be searched based on said at least one component; (c) calculating similarity measures among the plurality of images to be searched using the feature, and associating images that have the similarity measures within a predetermined range, with one another through links; and (d) calculating a display link distance between two images to be searched that are associated with each other through N links (where N is an integer equal to or larger than one), so as to set the display link distance between the two images to N, and searching the plurality of images.

According to a second aspect of the present invention, there is provided an image search method comprising the steps of: (a) extracting at least one component from each of a plurality of images to be searched, said at least one component being common to the plurality of images to be searched; (b) deriving a feature which characterizes each of the images to be searched based on said at least one component; (c) calculating similarity measures among the plurality of images to be searched using the feature, and associating images that have the similarity measures within a predetermined range, with one another through links; (d) generating a lower layer constituted by the images to be searched that are associated with one another in said step (c); (e) extracting, from the lower layer, images that are associated with one another through M links (where M is an integer equal to or larger than two), and setting images to be searched that constitute an upper layer higher than the lower layer by the extracted images; (f) in the upper layer, associating images that have the respective similarity measures within a predetermined range among the images to be searched, with one another through links; and (g) calculating a display link distance between two images to be searched that are associated with each other through N links (where N is an integer equal to or larger than one), so as to set the display link distance between the two images to N, and searching the plurality of images, wherein said steps (e) and (f) are recursively performed to generate a plurality of layers.

According to a third aspect of the present invention, there is provided an image search apparatus comprising: a storage device for accumulating a plurality of images to be searched; a feature acquisition unit for extracting at least one component from each of the plurality of images to be searched, said at least one component being common to the plurality of images to be searched, and for deriving a feature which characterizes each of the images to be searched based on said at least one component; a network generator for calculating similarity measures among the plurality of images to be searched using the feature, and associating images that have the similarity measures within a predetermined range, with one another through links; and an image search unit for calculating a display link distance between two images to be searched that are associated with each other through N links (where N is an integer equal to or larger than one), so as to set the display link distance between the two images to N, and searching the plurality of images.

According to a fourth aspect of the present invention, there is provided an image search apparatus comprising: a storage device for accumulating a plurality of images to be searched; a feature acquisition unit for extracting at least one component from each of the plurality of images to be searched, said at least one component being common to the plurality of images to be searched, and for deriving a feature which characterizes each of the images to be searched based on said at least one component; a network generator for calculating similarity measures among the plurality of images to be searched using the feature, and associating images that have the similarity measures within a predetermined range, with one another through links, and for generating a lower layer constituted by the associated images to be searched; and an image search unit for calculating a display link distance between two images to be searched that are associated with each other through N links (where N is an integer equal to or larger than one), so as to set the display link distance between the two images to N, and searching the plurality of images, wherein said network generator generates a plurality of layers by recursively performing the processes of: extracting, from the lower layer, images that are associated with one another through M links (where M is an integer equal to or larger than two); setting images to be searched that constitute an upper layer higher than the lower layer by the extracted images; and in the upper layer, associating images that have the respective similarity measures within a predetermined range among the images to be searched, with one another through links.

According to a fifth aspect of the present invention, there is provided a recording medium having an image search program code thereon. The image search program causing a computer to execute the following processing: storage processing for accumulating a plurality of images to be searched; feature acquisition processing for extracting at least one component from each of the plurality of images to be searched, said at least one component being common to the plurality of images to be searched, and for deriving a feature which characterizes each of the images to be searched on the basis of said at least one component; network generating processing for calculating similarity measures among the plurality of images to be searched using the feature, and for associating images that have the similarity measures within a predetermined range, with one another through links; and image search processing for calculating a display link distance between two images to be searched that are associated with each other through N links (where N is an integer equal to or larger than one), so as to set the display link distance between the two images to N, and for searching the plurality of images.

According to a sixth aspect of the present invention, there is a recording medium having an image search program code thereon. The image search program causing a computer to perform the following processing: storage processing for accumulating a plurality of images to be searched; feature acquisition processing for extracting at least one component from each of the plurality of images to be searched, said at least one component being common to the plurality of images to be searched, and for deriving a feature which characterizes each of the images to be searched based on said at least one component; lower layer generating processing for calculating similarity measures among the plurality of images to be searched using the feature, and associating images that have the similarity measures within a predetermined range, with one another through links, and for generating a lower layer constituted by the associated images to be searched; and image search processing for calculating a display link distance between two images to be searched that are associated with each other through N links (where N is an integer equal to or larger than one), so as to set the display link distance between the two images to N, and searching the plurality of images, wherein said image search program causing a computer to generates a plurality of layers by recursively performing upper layer generating processing for: extracting, from the lower layer, images that are associated with one another through M links (where M is an integer equal to or larger than two); setting images to be searched that constitute an upper layer higher than the lower layer by the extracted images; and in the upper layer, associating images that have the respective similarity measures within a predetermined range among the images to be searched, with one another through links.

### BRIEF DESCRIPTION OF THE DRAWINGS

FIG. 1 is a functional block diagram schematically showing a configuration of an image search apparatus of an embodiment according to the present invention;

FIG. 2 is a diagram schematically showing a still image divided into four blocks;

FIG. 3 is a diagram schematically showing a still image divided into five blocks;

FIG. 4 is a diagram schematically showing a series of video shots;

FIG. 5 is a diagram showing a relationship between images to be searched and corresponding features;

FIG. 6 is a schematic diagram showing a topology (a connection scheme) of a database;

FIG. 7 is a diagram schematically showing a data array of the database;

FIG. 8 is a flow chart showing a processing procedure of generating a network type database;

FIG. 9(a) is a diagram showing a data array of the network before registration of a new image; FIG. 9(b) is a diagram showing a data array of the network after registration of the new image;

FIG. 10 is a flow chart showing a procedure of search processing using the database;

FIG. 11 is a flow chart showing a procedure of list display processing;

FIG. 12 is a schematic diagram showing an example of display screen;

FIG. 13 is a schematic diagram showing an example of display screen;

FIG. 14 is a schematic diagram showing an example of a topology of the database;

FIG. 15 is a schematic diagram showing an example of a display screen;

FIG. 16 is a schematic diagram showing an example of a display screen;

FIG. 17 is a schematic diagram showing an example of a display screen;

FIG. 18 is a schematic diagram showing an example of a display screen;

FIG. 19 is a schematic diagram showing an example of a display screen;

FIG. 20 is a flow chart schematically showing a procedure of layering processing;

FIG. 21 is a diagram showing a topology as an example for describing one procedure of layering;

FIG. 22 is a diagram showing a topology as an example for describing one procedure of layering;

FIG. 23 is a diagram schematically showing a layered network type database;

FIG. 24 is a flow chart showing a procedure of image search processing using the layered network type database;

FIG. 25 is a flow chart showing a procedure of inter-layer movement processing;

FIG. 26 is a diagram illustrating one procedure of the inter-layer movement processing; and

FIG. 27 is a diagram illustrating one procedure of the inter-layer movement processing.

### MODE FOR CARRYING OUT THE INVENTION

In the following, various embodiments according to the present invention will be described with reference to the drawings.

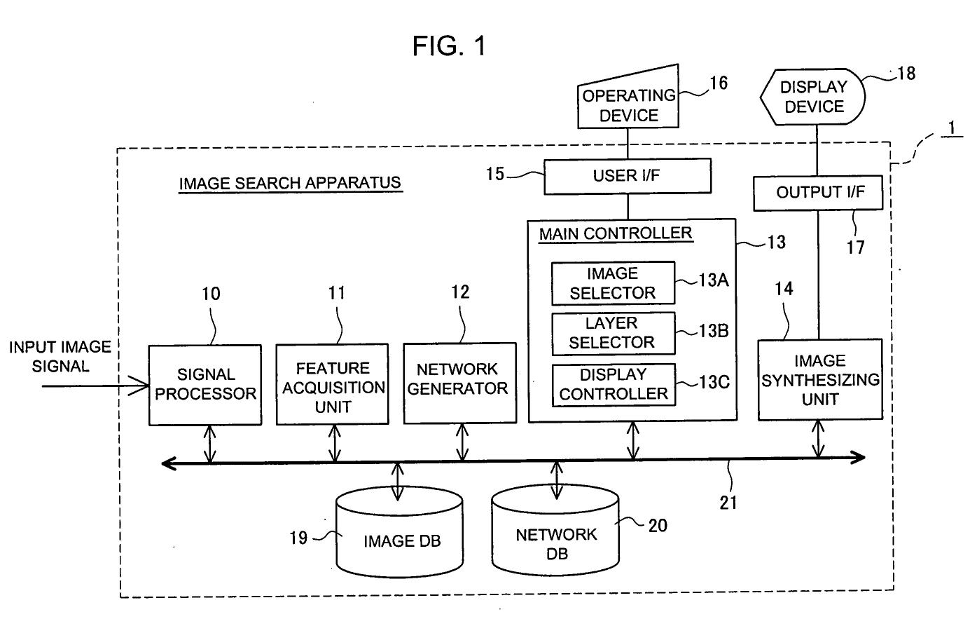

FIG. 1 is a functional block diagram schematically showing a configuration of an image search apparatus 1 of an embodiment according to the present invention. The image search apparatus 1 comprises a signal processor 10, a feature acquisition unit 11, a network generator 12, a main controller (image search unit) 13, an image synthesizing unit 14, an image database 19, and network database 20. These functional blocks 10-14, 19, 20 are mutually connected through a bus 21 which sends control signals and data signals.

The main controller 13 is connected to an operating device 16 through which user's instructions are entered, through a user interface 15. The image synthesizing unit 14 is connected to a display device 18 through an output interface 17. The display device 18 is a display device having a resolution that enables displaying of still images and moving images. The operating device 16, which can provide entered instructions to the main controller 13 through the user interface 15, concretely includes a pointing device such as a keyboard or a mouse for detecting a coordinate position on the screen of the display device 18. As the operating device 16, a touch screen can be employed for sensing a position touched by a finger or the like of the user on the screen of the display device 18 to give instructions in accordance with the detected position to the main controller 13. A voice recognition apparatus can also be employed for recognizing a voice spoken by the user to give the result to the main controller 13.

The main controller 13 has a function of controlling operations of the functional blocks 10-14, 19, 20, and includes a layer selector 13A for executing a variety of search processing tasks, an image selector 13B, and a display controller 13C. The main controller 13 can be made up of a integrated circuit which includes a microprocessor, a ROM storing a control program and the like, a RAM, an internal bus, an input/output interface, and the like. The layer selector 13A, image selector 13B and display controller 13C can be implemented by a program code or sequence of instructions to be performed by the microprocessor, or implemented by hardware. In this embodiment, the feature acquisition unit 11 and network generator 12 are implemented by hardware independent of each other, and, alternatively, may be implemented by a program code or sequence of instructions to be performed by the microprocessor of the main controller 13.

An image search program code causing the microprocessor to perform the search processing of the feature acquisition unit 11, network generator 12 and main controller 13 may be used and recorded on a recording medium such as HDD, non-volatile memory, optical disk, magnetic disk or the like.

The signal processor 10 has a function of receiving an input image signal from an outside source, and transferring the received signal to the image database 19 through the bus 21 at a predetermined timing. When an analog input image signal is received, the signal processor 10 transfers the input image signal to the image database 19 after A/D conversion. As a coding scheme for the input image signal, there are still image coding schemes such as JPEG (Joint Photographic Experts Group), GIF (Graphic Interchange Format), bit map and the like, and are moving image coding schemes such as Motion-JPEG, AVI (Audio Video Interleaving), MPEG (Moving Picture Experts Group) and the like. As a source supplying the input video signal, a movie camera, a digital camera, a television tuner, a DVD player (Digital Versatile Disk Player), a compact disk player, a mini-disk player, a scanner, and a wide area network such as the Internet can be used.

The image database 19 is built in a large capacity storage device such as an HDD. The image database 19 stores and manages still images and moving images (hereinafter referred to as “images to be searched”) transferred through the bus 21, in accordance with a conventional file system. As will be later described, the feature acquisition unit 11 and network generator 12 generate a network type database by associating the images to be searched recorded in the image database 19 with one another in a network arrangement, and records the associated images in the network database 20.

The feature acquisition unit 11 is a functional block that performs processing (feature acquisition processing) for deriving features of each of a large number of images to be searched. Specifically, the feature acquisition unit 11 extracts, from a large number of images to be searched, components being common to the images to be searched recorded in the image database 19. For example, the feature acquisition unit 11 extracts meta data or a set of color components constituting each pixel. As one set of color components, there are a set of color components of R (red), G (green) and B (blue), and a set of color components of Y (luminance), Cb (color difference) and Cr (color difference). As the meta data, there is such information as attributes added to the images to be searched, meaning contents, a source of the each image, or a storage location. More specifically, such information as a title, a recording date and time (absolute time/relative time), a captured location (latitude/longitude/altitude), a category, performers, keywords, comments, a price (yen/dollar/euro), and an image size can be extracted as the meta data.

The feature acquisition unit 11 calculates a set of feature values, i.e., a feature which characterizes each of the images to be searched on the basis of the components extracted from the images to be searched. The network generator 12 calculates similarity measures between the images to be searched by using the feature calculated by the feature acquisition unit 11, selects images having similarity measures that falls within a predetermined range, and associates the selected images with one another through links, thereby generating a network type database. In the following a description will be given of a method of calculating the similarity measures when the images to be searched are still images, and the components extracted from the still images are color components of R, G, and B.

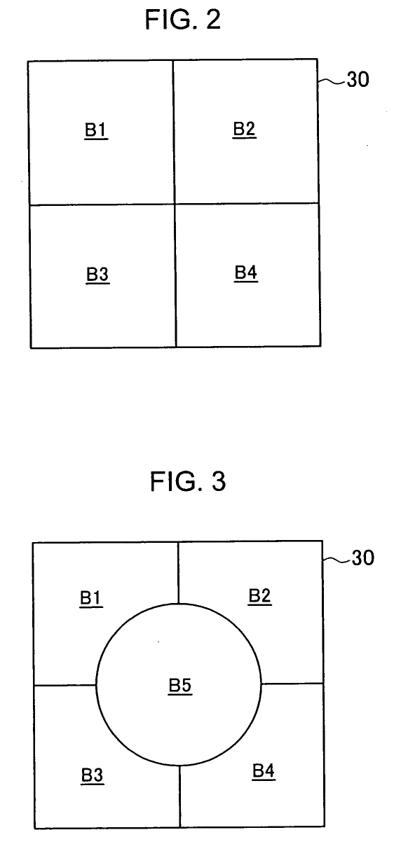

The feature acquisition unit 11 reads still images from the image database 19, and divides each of the read still images into M blocks (where M is an integer equal to or larger than two). For example, as shown in FIG. 2, a still image 30 can be divided into four blocks B1, B2, B3, B4, and, alternatively as shown in FIG. 3, the still image 30 can be divided into five blocks B1, B2, B3, B4, B5. Next, feature values, i.e., an average value of the R-components, an average value of G-components and an average value of B-components for each block are calculated.

We suppose that in an (m+1)th block (where m is a positive integer) of a k-th still image (where k is a positive integer) stored in the image database, the i-th R-component, G-component, and B-component (where i is a positive integer) are represented by rᵢ(k,m), gᵢ(k,m), and bᵢ(k,m), respectively. We also suppose that average values of the R-components, G-components, and B-components for an m-th block are represented by <r(k,m)>, <g(k,m)>, and <b(k,m)>, respectively. The average values <r(k,m)>, <g(k,m)>, and <b(k,m)> are given by the following equation (1):

$$\{ \begin{matrix}< r ( k , m ) >= \frac{1}{N} {\sum }_{i = 1}^{N} {r}_{i} ( k , m ) = x ( k , 3 m - 2 ) , \\ < g ( k , m ) >= \frac{1}{N} {\sum }_{i = 1}^{N} {g}_{i} ( k , m ) = x ( k , 3 m - 1 ) , and \\ < b ( k , m ) >= \frac{1}{N} {\sum }_{i = 1}^{N} {b}_{i} ( k , m ) = x ( k , 3 m ) .\end{matrix} \qquad ( 1 )$$

The above equation (1) gives arithmetic mean values of the R-components, G-components, and B-components, respectively. Instead of the arithmetic mean values, geometric mean values, harmonic mean values, or weighted arithmetic mean values may be calculated with respect to the R-components, G-components, and B-components, respectively. The arithmetic mean value gives (a+b)/2 for two values “a” and “b,” the geometric mean value gives (ab)^{1/2} for two positive values “a” and “b,” the harmonic mean value gives an inverse (=2ab/(a+b)) of an arithmetic mean value for the inverses of two values “a” and “b,” and the weighted arithmetic mean value gives a value (=αa+βb) for the two values “a” and “b” by multiplying the values “a” and “b” by their respective coefficients “α” and “β”, and by adding the multiplications.

Next, when x(k,3m−2), x(k,3m−1), and x(k,2m) are defined as shown in the above Equation (1), a vector Xₖ in 3×M dimensions is constituted as given by the following Equation (2):

$${X}_{k} = \{ \begin{matrix}x ( k , 1 ) , x ( k , 2 ) , x ( k , 3 ) , … , x ( k , 3 m - 2 ) , x ( k , 3 m - 1 ) , \\ x ( k , 3 m ) , … , x ( k , 3 M - 2 ) , x ( k , 3 M - 1 ) , x ( k , 3 M )\end{matrix} \} . \qquad ( 2 )$$

By treating the vector Xₖ as one element in a metric space, a Euclidean distance can be defined between two images to be searched. Specifically, an Euclidean distance D(p,q) between a p-th image (where p is a positive integer) and a q-th image (where q is a positive integer) is defined by the following Equation (3):

$$D ( p , q ) = ‖ {X}_{p} - {X}_{q} ‖ = \sqrt{{\sum }_{j = 1}^{Nr} {( x ( p , j ) - x ( q , j ) )}^{2}} , \qquad ( 3 )$$

where Nr=3M.

The feature acquisition unit 11 regards the vector Xₖ as a unique feature which characterizes the images to be searched, and calculates the Euclidean distances D(p,q) as similarity measures. In this embodiment, as two images to be searched are more similar to each other, the Euclidean distance is smaller, and the similarity measure takes a smaller value. Alternatively, an inverse of the Euclidean distance may be defined as a similarity measure, and the configuration may be modified such that the similarity measure takes a larger value as two images to be searched are more similar to each other.

Instead of the Euclidean distance, the Manhattan distance (i.e., street distance) may be used. The Manhattan distance is defined by the following equation (3A):

$$D ( p , q ) = ‖ {X}_{p} - {X}_{q} ‖ = {\sum }_{j = 1}^{Nr} \vert x ( p , j ) - x ( q , j ) \vert , \qquad ( 3 A )$$

where Nr=3M.

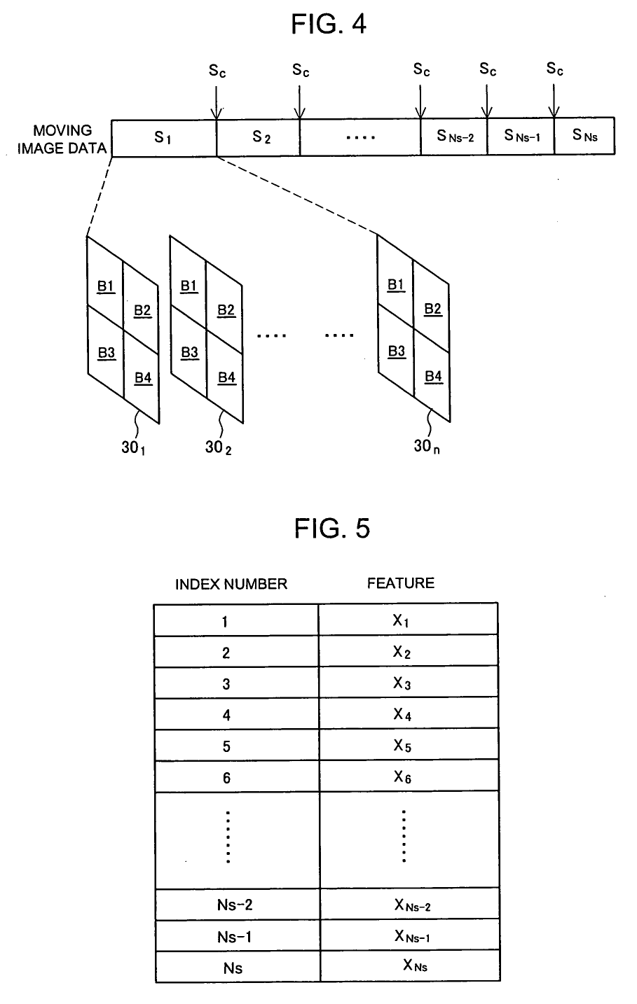

Next, descriptions will be given of a method of calculating the similarity measures when the images to be searched are moving images composed of a plurality of frames, and components extracted from each frame are color components of R, G, and B. As shown in FIG. 4, moving image data is composed of a sequence of video shots S₁, S₂, . . . , S_{Ns} (where Ns is an integer equal to or larger than two), and each video shot is composed of a plurality of frames. For example, the first video shot S₁ is composed of n sequential frames 30₁, 30₂, 30ₙ (where n is an integer equal to or larger than two). Cut points (i.e., scene changes) Sc, Sc, . . . occur between sequential video shots, where the correlation between frames becomes extremely small. The feature acquisition unit 11 can identify each video shot by detecting each scene change Sc.

The feature acquisition unit 11 divides each video shot Sₖ (where k is an integer from 1 to Ns) into M blocks B1, B2, . . . (where M is an integer equal to or larger than two). For example, each frame can be divided into four, as shown in FIG. 4. Next, the feature acquisition unit 11 calculates the average values of R-components, average values of G-components, and average values of B-components for their respective blocks, and averages the average values over a plurality of frames to calculate feature values. Specifically, when the i-th R-component, G-component, and B-component in the m-th block of the s-th frame (where s is an integer from 1 to Nₖ; Nₖ is a positive integer) of the k-th video shot Sₖ are denoted by r(i,s; k,m), g(i,s; k,m), and b(i,s; k,m), respectively, feature values <R(k,m)>, <G(k,m)>, and <B(k,m)> which characterize the k-th video shot Sₖ for the (m+1)th block are given by the following Equation (4):

$$\{ \begin{matrix}\begin{matrix}< R ( k , m ) >= \frac{1}{{N}_{k}} {\sum }_{s = 1}^{{N}_{k}} ( \frac{1}{N} {\sum }_{i = 1}^{N} r ( i , s ; k , m ) ) \\ = x ( k , 3 m - 2 ) ,\end{matrix} \\ \begin{matrix}< G ( k , m ) >= \frac{1}{{N}_{k}} {\sum }_{s = 1}^{{N}_{k}} ( \frac{1}{N} {\sum }_{i = 1}^{N} g ( i , s ; k , m ) ) \\ = x ( k , 3 m - 1 ) ,\end{matrix} \\ and \\ \begin{matrix}< B ( k , m ) >= \frac{1}{{N}_{k}} {\sum }_{s = 1}^{{N}_{k}} ( \frac{1}{N} {\sum }_{i = 1}^{N} b ( i , s ; k , m ) ) \\ = x ( k , 3 m ) .\end{matrix}\end{matrix} \qquad ( 4 )$$

Next, by defining x(k,3m−2), x(k,3m−1), and x(k,3m) as shown in the above Equation (4), the vector Xₖ given by the above Equation (2) can be constituted. The vectors Xₖ can be treated as elements in the metric space, and the Euclidean distance D(p,q) between two video shots can be defined as a similarity measure as shown in the above Equation (3). As a value which decreases as the Euclidean distance D(p,q) increases, for example, its inverse may be defined as the similarity measure.

Next, descriptions will be given of a method of calculating similarity measures when components extracted from the images to be searched are meta data. The feature acquisition unit 11 has a function of calculating a value proportional or reciprocally proportional to a matching rate of the meta data between the images to be searched as the similarity measure by using the meta data or information included in the meta data as a feature. Specifically, when the meta data includes value information such as a date and time when the image was captured, a location where the image was captured, and a price, the value information can be treated as the feature Xₖ, and a difference between a feature Xₚ of the p-th image and a feature X_{q} of the q-th image can be calculated as a similarity measure D(p, q).

When the meta data includes information which is difficult to represent in values, such as categories, keywords and the like, values in the categories or keywords, for example, an objective index such as “90 percent of fun index, 90 percent of exciting index” can be employed as the feature Xₖ, and a difference between a feature Xₚ of the p-th image and a feature X_{q} of the q-th image can be calculated as a similarity measure D(p, q).

Further, when the meta data includes a code sequence which cannot be represented in values such as a title, name of an actor, or comments, by using the code sequence as the feature Xₖ, a value proportional to a matching rate or non-matching rate between a character string Xₚ of the p-th image and a character string X_{q} of the q-th image can be calculated as a similarity measure D(p, q). For example, when two character strings Xₚ and X_{q} match, the similarity measure D(p, q) can be set to “1,” and when the two character strings Xₚ, X_{q} do not match, the similarity measure D(p, q) can be set to “0.” Alternatively, when two character strings Xₚ and X_{q} completely match, the similarity measure D(p, q) can be set to “2,” the two character strings Xₚ and X_{q} match in part, the similarity measure D(p, q) can be set to “1,” and the two character strings Xₚ and X_{q} do not completely match, the similarity measure D(p, q) can be set to “0.”

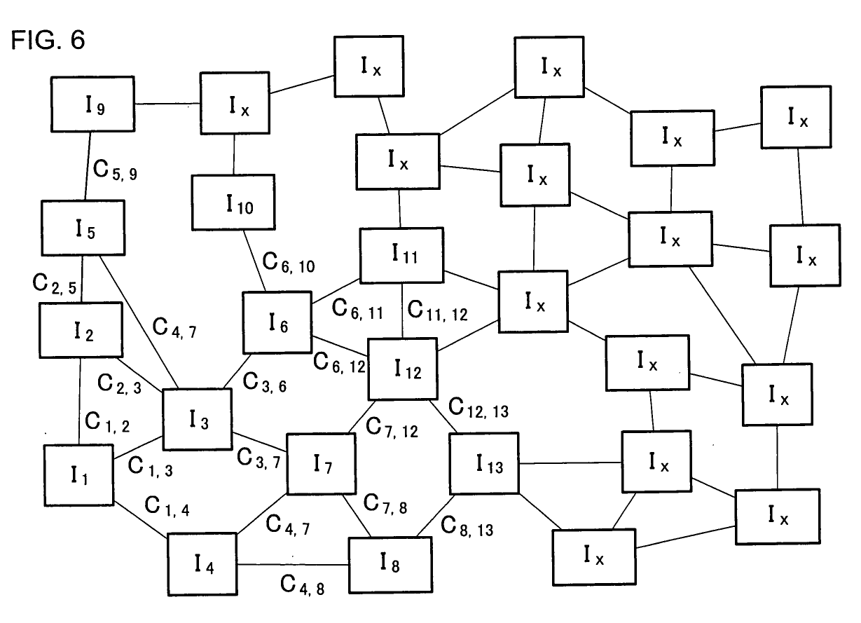

The feature acquisition unit 11 calculates the feature Xₖ, and stores the features Xₖ corresponding to their respective images to be searched into the network database 20. FIG. 5 is a schematic diagram showing a relationship between the k-th image and its corresponding feature Xₖ. Each image to be searched is indicated by an index number k, and a feature Xₖ corresponding to this index number is stored in the network database 20. The network generator 12 calculates a similarity measure D(p, q) between two images to be searched with reference to the correspondence table as shown in FIG. 5. Next, the network generator 12 determines whether or not the similarity measure D(p, q) satisfies a relational expression shown in the following Equation (5), determines that the p-th image and q-th image are similar to each other when the following relational expression (5) is satisfied, and associates those similar images to be searched with one another to generate a network type database which is to be stored in the network database 20.

D(p,q)<Rth. (5)

In the above Equation (5), Rth indicates a threshold for the similarity measure. The threshold Rth is desirably set to a value which enables each image to be searched to be associated with 5-10 images on average. Each display link distance between the associated images to be searched is set to the same value. In this embodiment, the display link distance is set to “1,” no limitation thereto intended.

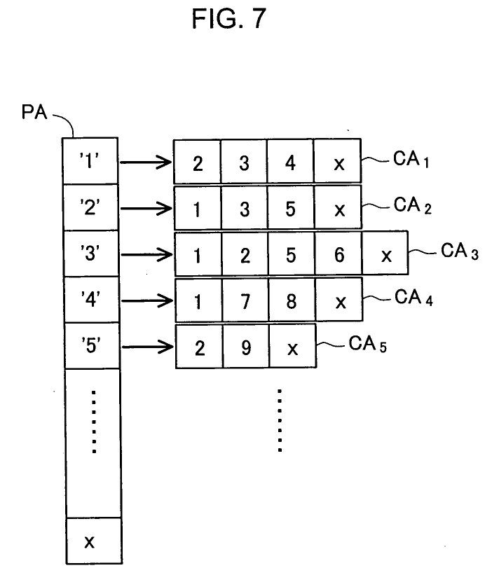

FIG. 6 is a schematic diagram showing a topology (i.e., a connection scheme) of a network type database; and FIG. 7 is a diagram schematically showing a data array of the network type database. Referring to FIG. 6, the images to be searched I₁, I₂, . . . are associated with each other through links C_{1,2}, C_{1,4}, . . . . The link C_{p,q} is a connection line indicative of the relation between two images Ip, Iq to be searched, and the length of each link (i.e., a display link distance) is set to “1.” The images to be searched I₁, I₂, . . . may be regarded as being placed at both end positions (nodes) of the links C_{1,2}, C_{1,4}.

The display link distance between two of the images to be searched is “N” when they are associated with each other through N links (where N is an integer equal to or larger than one). The display link distance between the images to be searched Iₚ, I_{q} can be defined to be the number of links on the shortest path from one image Iₚ to the other image I_{q} to be searched. For example, the image I₁ to be search is indirectly associated with the image I₅ through one image I₂, and associated with the image I₉ through two images I₂, I₅. The display link distance between the image I₁ and image I₅ is “2,” and the display link distance between the image I₁ and image I₉ is “3.”

Referring to FIG. 7, the data array of the network type database has a double array structure comprised of an image array PA and connection arrays CA₁, CA₂, . . . . The image array PA is an array for storing pointers ‘1,’ ‘2,’ ‘3,’ . . . to the connection arrays CA₁, CA₂, . . . ; and the connection arrays CA₁, CA₂, . . . are arrays of index numbers of the images I₁, I₂, . . . to be searched. Image numbers are sequentially arranged in an ascending order. X indicates a symbol representing the end of the image array or connection array.

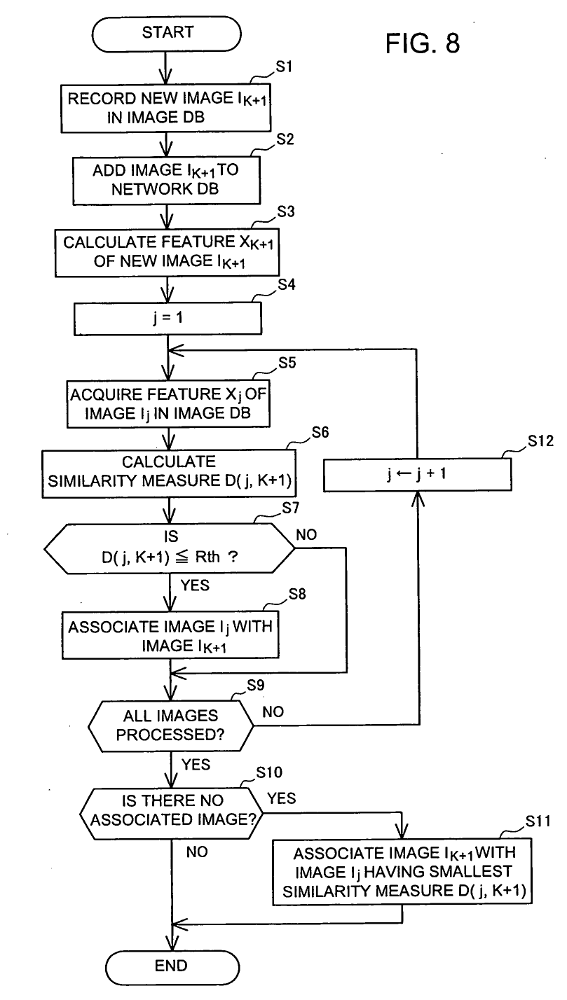

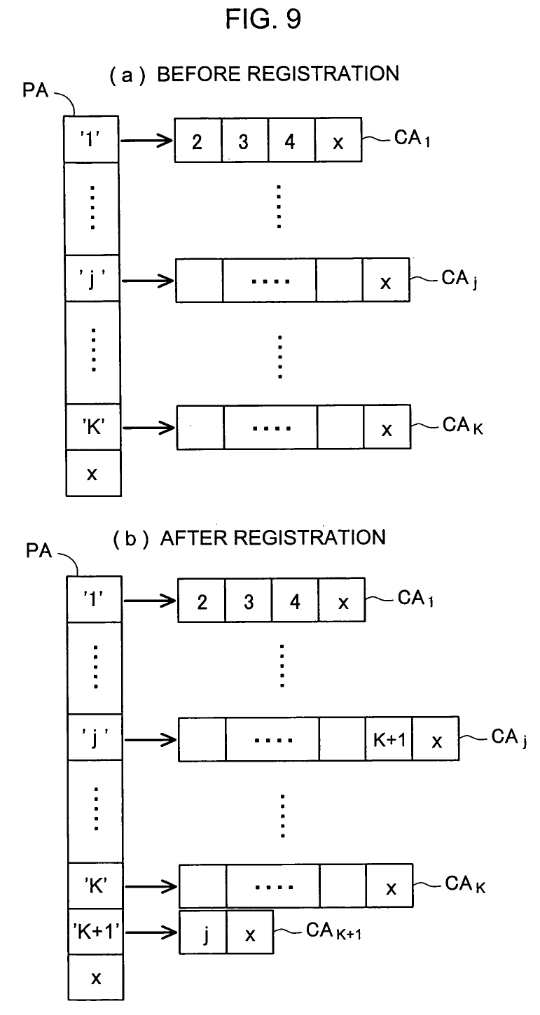

Referring next to FIG. 8, descriptions will be given of a procedure of network type database generating processing. The following descriptions will be given of processing for registering a (K+1)th new image I_{K+1} in a network database which has been previously built with K images to be searched (where K is an integer equal to or larger than zero). In this case, as shown in FIG. 9(a), a data array of the new image I_{K+1} before the registration is composed of connection arrays CA₁ to CA_{K}, and an image array PA having pointers ‘1,’ ‘2,’ ‘3,’ . . . ‘K’ to their respective connection arrays. The case of K=0 is a case when a new database is to be built.

Referring to FIG. 8, at first, the main controller 13 records the new image I_{K+1} input from the signal processor 10 in the image database (step S1), and adds the new image I_{K+1} to the network database 20 (step S2). In this event, as shown in FIG. 9(b), an area of a connection array CA_{K+1} is prepared for the new image I_{K+1}, and a pointer ‘K+1’ to the connection array CA_{K+1} is added to the image array PA.

Next, the main controller 13 causes the feature acquisition unit 11 to calculate a feature X_{K+1} of the new image K_{K+1} (step S3). In this event, the feature acquisition unit 11 extracts components such as R, G, B color components, meta data or the like from the new image I_{K+1}, and calculates the feature X_{K+1} using the components, and records the result in the network database 20.

Through subsequent steps S4 to S9, an association processing between registered images I₁ to Iₖ and the new image I_{K+1} is performed. Specifically, an image number j is set to an initial value (=1) (step S4). Next, the feature acquisition unit 11 acquires a feature Xⱼ of the j-th image Iⱼ recorded in the image database 19 (step S5). The feature acquisition unit 11 may newly calculate the feature Xⱼ of the j-th image Iⱼ instead of acquiring the feature Xⱼ from the network database 20.

Subsequently, the network generator 12 calculates a similarity measure D(k, K+1) between the j-th image Iⱼ and the new image I_{K+1} by using the features Xⱼ, X_{K+1} (step S6). Further, the network generator 12 determines whether or not the similarity measure D(j, K+1) satisfies the aforementioned relation expression (5) (step S7). When it is determined that the similarity measure D(j, K+1) does not satisfy the relational expression (5), the procedure proceeds to step S9.

On the other hand, when it is determined at step S7 that the similarity measure D(j, K+1) satisfies the relational expression (5), the network generator 12 determines that the j-th image Iⱼ and the new image I_{K+1} are similar to each other, and associates the images Iⱼ, I_{K+1} with each other (step S8). Specifically, as shown in FIG. 9(b), the image number j of the j-th image Iⱼ is added to the connection array CA_{K+1} for the new image I_{K+1}, and the image number K+1 of the new image I_{K+1} is added to the connection array CAⱼ corresponding to a pointer ‘j’ of the image array PA. Then, the network generator 12 records this data array in the network database 20. Subsequently, the procedure proceeds to step S9.

At step S9, the main controller 13 determines whether or not the processing has been completed for all the images I₁ to I_{K}. When determining that the processing has not been completed, the main controller 13 increments the image number j (step S12), and repeatedly executes the procedure starting at step S5. On the other hand, when determining that the processing has been completed for all the images I₁ to I_{K} (step S9), the main controller 13 determines whether or not there is no associated image in the aforementioned step S8 (step S10). If it is determined in the step S10 that there is one or more associated images, the database generating processing is terminated. On the other hand, if it is determined in the step S10 that there is no associated image, the network generator 12 associates the image Iⱼ having the smallest value of the similarity measure D(j, K+1) with the new image I_{K+1} (step S11). Then, the database generating processing is completed.

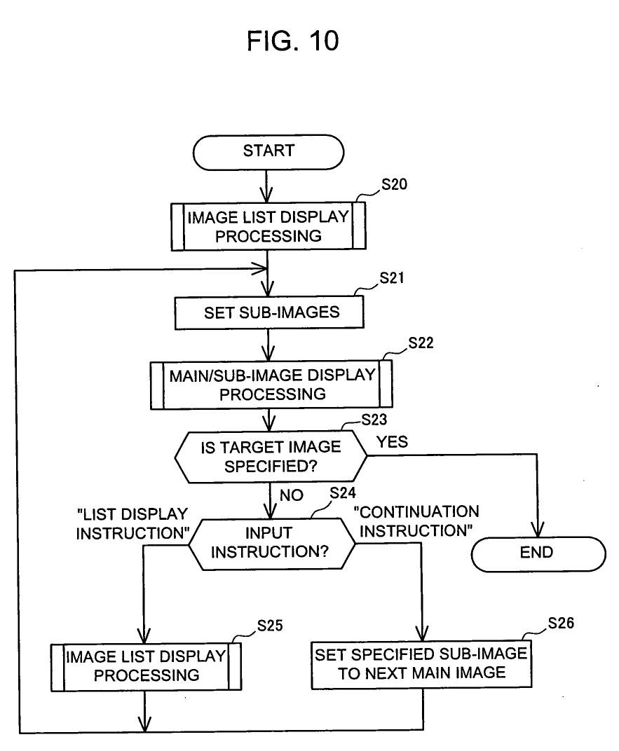

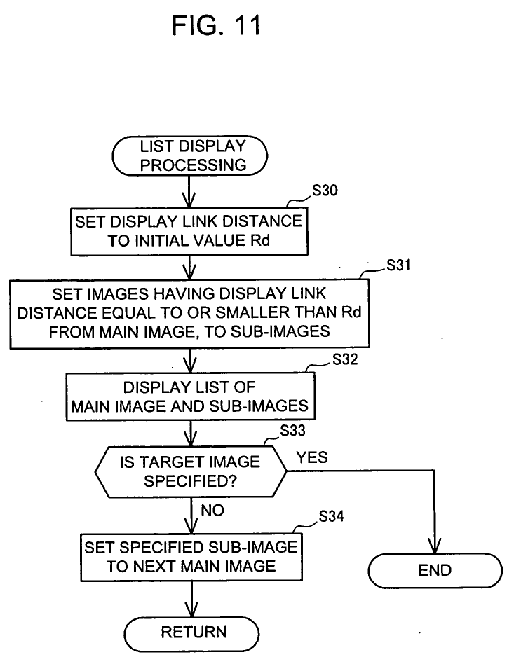

Referring next to FIGS. 10 and 11, descriptions will be given of search processing using the network type database. FIG. 10 is a flow chart showing a procedure of image search processing; and FIG. 11 is a flow chart showing a procedure of list display processing to be used in the flow chart of FIG. 10.

First, in response to an input instruction from the operating device 16, the main controller 13 performs the image list display processing (FIG. 11). Referring to FIG. 11, the image selector 13B (FIG. 1) sets a display link distance to an initial value Rd (step S30), and, with reference to the network database 20, sets, as a sub-image, an image which has a display link distance equal to or smaller than the initial value Rd from a main image (step S31). The initial value Rd can be specified by the user through the operating device 16. If no value is specified in particular, the initial value Rd is set to a previously registered value of, for example, “5.” Also, the main image can be arbitrarily selected from images registered in the network database 20. If no image is specified in particular, the image I₁ having the image number of “1” can be selected as the main image.

Next, the display controller 13C displays the main image and sub-images selected in the step S31 on one screen of the display device 18 in a list (step S32). Specifically, the display controller 13C reads the main image and sub-images recorded in the image database 19, and transfers the read images to the image synthesizing unit 14 through the bus 21. The image synthesizing unit 14 converts resolutions of the transferred main image and sub-images to generate images in a thumbnail-size, synthesizes the generated images, and output the synthesized images to the display device 18 through the output interface 17. The thumbnail-size images are preferably displayed in an ascending order of the link distance from the main image to preferentially display the sub-images which have higher similarity measures for the main image.

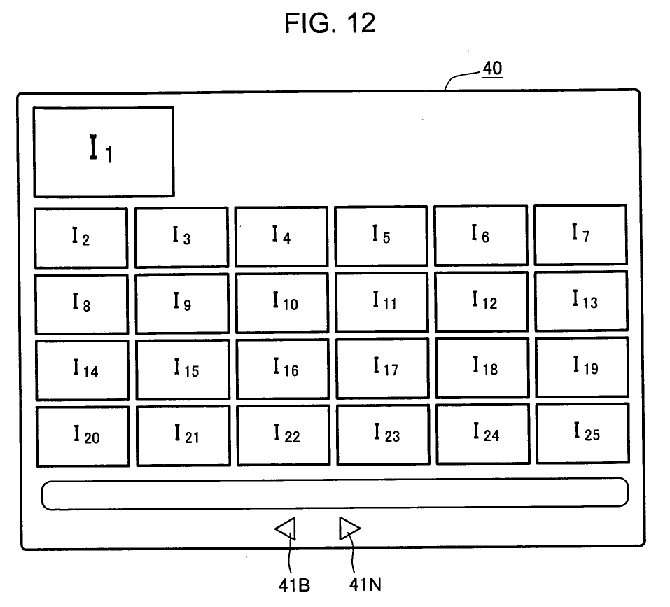

FIG. 12 schematically illustrates a display screen 40 of the display device 18. The main image I₁ is displayed on the display screen 40, together with sub-images I₂ to I₂₅ similar to the main image I₁. When all sub-images cannot be displayed on one screen, the user can display a list of remaining sub-images on the next screen by manipulating the operating device 16 for input to specify a next screen selection button 41N. The user can return the display screen to the previous screen by specifying a previous screen selection button 41B. When the thumbnail-size images of the main image and sub-images can be generated and stored in the image database 19 in advance, the image synthesizing unit 14 reads the thumbnail-size images instead of reading the main image and sub-images of a high resolution from the image database 19.

When finding a target image, the user can specify the target image from the images displayed on the screen 40 by manipulating the operating device 16 for input. On the other hand, when no target image can be found by the user, the user can also specify a sub-image other than the target image as the next main image by manipulating the operating device 16 for input. The image selector 13B detects an input instruction from the operating device 16 to determine whether a target image is specified or not (step S33). When the user specifies a target image, the image selector 13B determines that a target image is specified, and terminates the processing procedure. On the other hand, when the user specifies a sub-image other than the target image as the next main image, the image selector 13B determines that no target image is specified (step S33), sets the specified sub-image to the main image (step S34), and then returns the processing procedure to the main routine (FIG. 10).

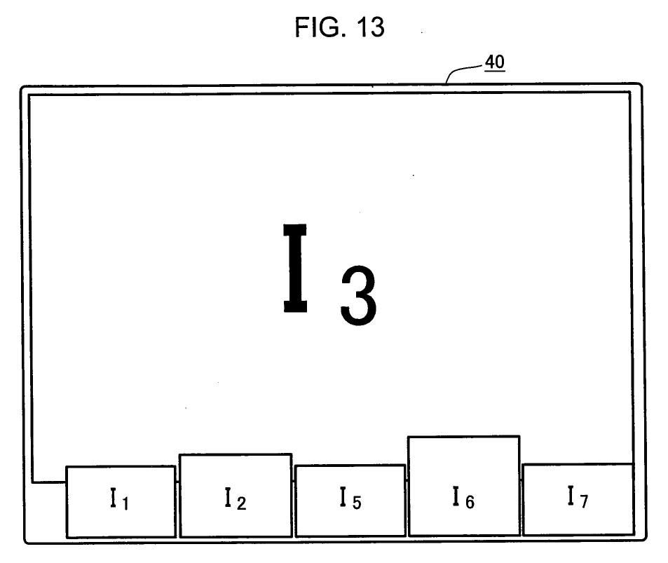

At step S21 in the main routine, the image selector 13B sets, as sub-images, images which have a distance equal to or smaller than the set value Rs from the main image (step S21). Subsequently, the display controller 13C displays the main image and sub-images in a list on the display device 18 (step S22). The user can change the set value Rs held by the main controller 13 as appropriate by manipulating the operating device 16 for input. For example, in the case of the database shown in FIG. 6, when the set value Rs is set to “1” with respect to the main image I₁, the image selector 13B sets, as sub-images, images I₁, I₃, I₄ which have the display link distance equal to or smaller than “1” from the main image I₁. When the set value Rs is set to “3,” the image selector 13B sets, as sub-images, images I₁, I₃, I₄, I₅, I₆, I₇, I₈, I₉, I₁₀, I₁₁, I₁₂, I₁₃ which have the display link distance equal to or smaller than “3” from the main image I₁. FIG. 13 is a diagram showing an example of the display screen 40 on the display device 18. On the display screen 40, the thumbnail-size main image I₃ together with the thumbnail-size sub-images I₁, I₂, I₅, I₆, I₇ which have the display link distance equal to or smaller than “1” from the main image I₃ are displayed in a list.

The user can specify a desired target image of the images displayed on the screen 40 by manipulating the operating device 16 for input. The image selector 13B detects an input instruction from the operating device 16 to determine whether a target image is specified or not (step S23). When the user specifies a target image, the image selector 13B determines that the target image is specified, and terminates the image search processing.

On the other hand, when the user does not specify the target image but inputs another instruction, the image selector 13B determines that no target image is specified (step S23), and subsequently, the processing procedure proceeds to either step S25 or S26 in accordance with the type of the input instruction (step S24). When the input instruction is a “list display instruction,” the list display processing (FIG. 11) at step S25 is performed, and subsequently, the processing procedure starting at step S21 is repeatedly executed. On the other hand, when the user inputs an instruction for changing one of the sub-images on the display screen 40 to the main image, the image selector 13B determines that there is a “continuation instruction” (step S24), and sets the specified sub-image to the next main image (step S26). Subsequently, the processing procedure starting at step S21 is repeatedly executed.

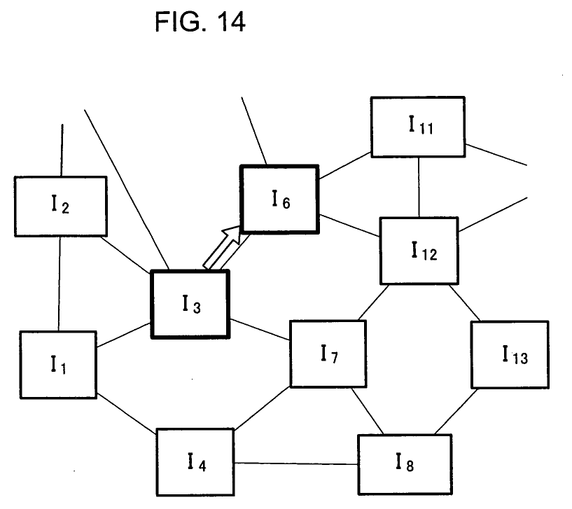

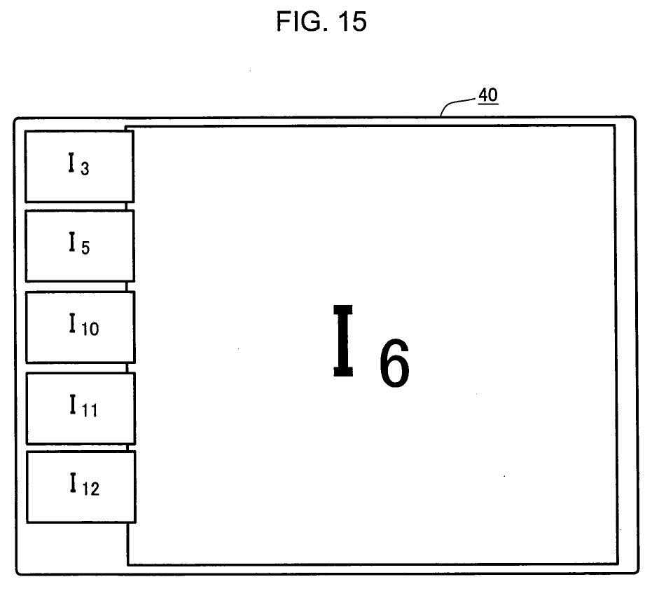

For example, when the user inputs the continuation instruction to specify the sub-image I₆, the main image is changed from the image I₃ to the image I6 as shown in FIG. 14, and the display screen 40 is changed to the screen shown in FIG. 15. On the display screen shown in FIG. 15, the thumbnail-size main image I6 and the thumbnail-size sub-images I3, I5, I10, I11, I12 which have the display link distance equal to or smaller than “1” from the main image I6 are also displayed in a list. When there is no sub-image to be specified as a main image on the display screen 40, for example, the user can cause the display screen to display a large number of thumbnail-size images in a list (step S25) as shown in FIG. 12, and thereby can promptly find an image to be specified as a main image.

In this way, the user can efficiently and conveniently search for a desired target image. Also, since the image search processing mainly uses only the link information in the database, the search processing can be performed at high speed with less calculation and without complicated procedure.

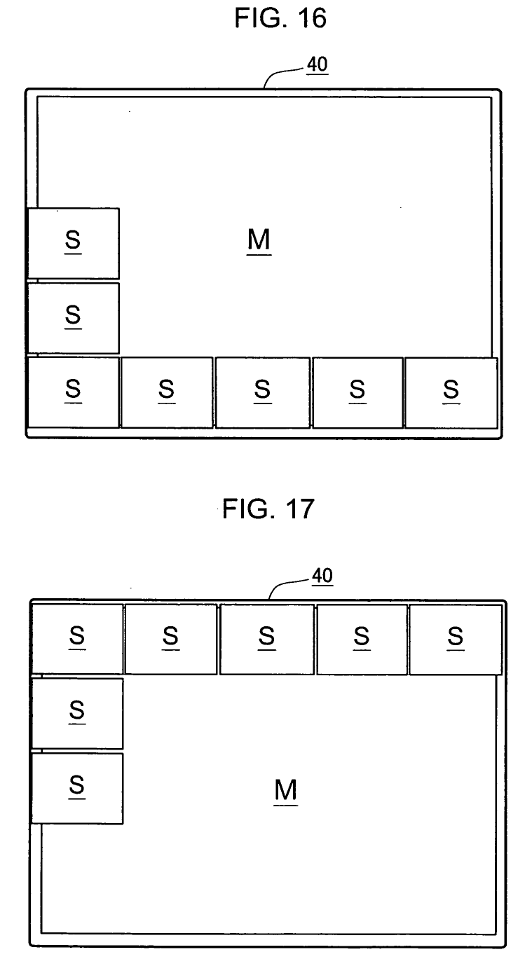

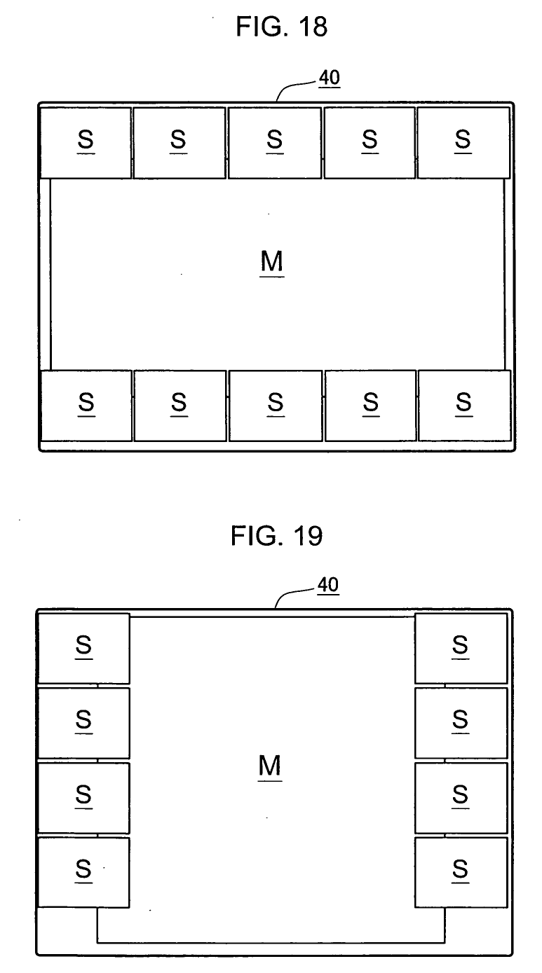

On the screen illustrated in FIG. 13, since the main image I₃ has a large number of horizontal pixels and a small number of vertical pixels as compared with the entire display area, the main image I₃ is positioned upward, and the sub-images I₁, I₂, . . . are arranged along the horizontal direction so as to reduce areas which would overlap the main image I₃. On the other hand, on the screen 40 shown in FIG. 15, since the main image I₆ has a small number of horizontal pixels and a large number of vertical pixels as compared with the entire display area, the main image I₆ is positioned rightward, and the sub-images I₃, I₅, . . . are arranged along the vertical direction so as to reduce areas which would overlap the main image I₆. In this way, the display controller 13C can design an appropriate layout in accordance with image sizes of the main image and sub-images. Other than the layouts shown in FIGS. 13 and 15, layouts shown in FIGS. 16 to 19 are also appropriate. In the figures, “M” indicates a main image, and “S” indicates sub-images.

In the image search processing described above, the sub-images displayed on the display screen 40 are a set of images which have display link distances equal to or smaller than the set value Rs from the main image. Instead of this, a set of images which have display link distances with the main image equal to the set value Rs or in a predetermined range centered at the set value Rs may be displayed on the display screen 40 as the sub-images. For example, when Rs=3 as the set value, a set of images having the display link distance of “3” from the main image may only be displayed on the display screen 40. Alternatively, a set of images having the display link distances of “2,” “3,” or “4” may only be displayed on the display screen 40.

Next, descriptions will be given of layering processing using the network type database (hereinafter referred to as the “network”) described above. The network generator 12 is capable of building a network of an upper layer on the basis of the network (hereinafter referred to as the zero-th order network) which is built through the processing procedure shown in FIG. 8. Specifically, the network generator 120 extracts, from the zero-th order network, a set of images to be searched indirectly associated with one another through N images to be searched (where N is an integer equal to or larger than one), and allows the extracted images to be constituted as a set of images belonging to a higher layer. Further, the network generator 12 generates a network of the first-order layer by associating the extracted images which are indirectly associated with one another on the zero-th order network, with one another on the higher layer, and by setting the display link distances between the associated images to be searched to “1.” By recursively performing the foregoing processing procedure, networks of yet higher layers can be built.

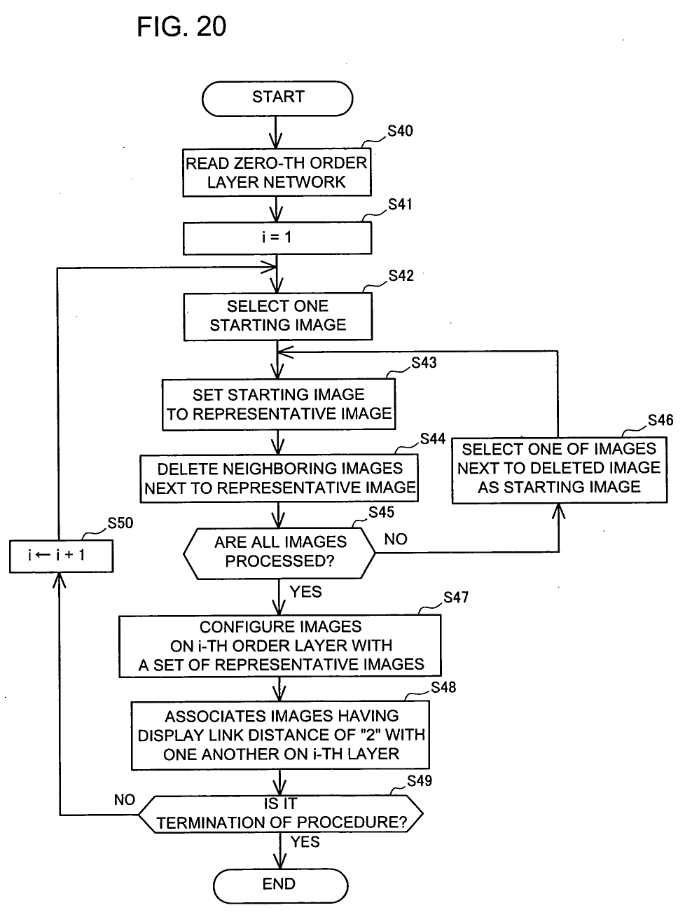

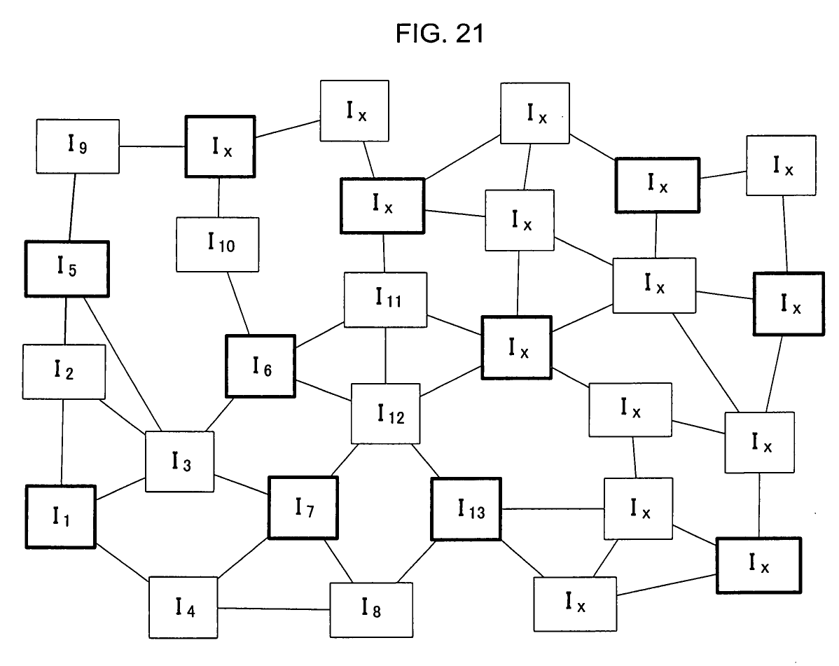

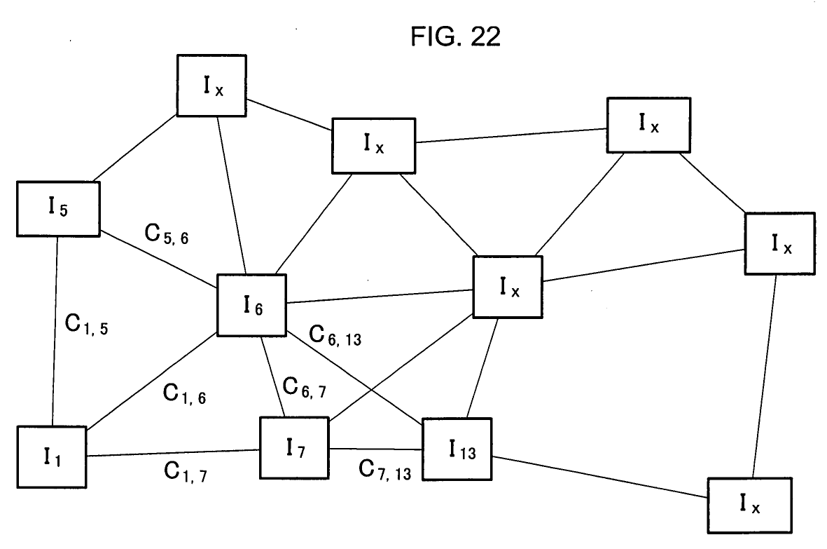

In the following, one embodiment of the layering processing to be performed by the network generator 12 will be described with reference to FIG. 20. FIG. 20 is a flow chart schematically showing a procedure of the layering processing. First, the network generator 12 reads the network of the zero-th order layer from the network database 20 (step S40), and sets the layer number i to “1” for generating a network on the first-order layer (step S41). Subsequently, a starting image is selected from a plurality of images belonging to the zero-th order layer (step S42). While an arbitrary image can be selected as the starting image by the user through the operating device 16, an image having the smallest image number can be selected if no particular image is specified. FIG. 21 is a schematic diagram showing a topology of the network of the zero-th order layer. In the FIG. 21, an image I₁ is selected as the starting image.

Next, the network generator 12 sets the starting image as a representative image (step S43), and deletes all neighboring images which are next to the representative image, i.e., those images which have the display link distance of “1” from the representative image (step S44). For example, as shown in FIG. 21, images I2, I3, I4 next to the representative image I1 are deleted. Subsequently, the network generator 12 determines whether or not all images have been processed (step S45), and allows the processing procedure to proceed to step S47 when determining that all images have been processed. The network generator 12 allows the processing procedure to proceed to step S46 when determining that all images have not been processed.

At step 46, an image next to the images deleted in the step S44 is selected as the next starting image (step S46). The image having the smallest image number can be selected from a plurality of images of interest as the next starting image, and the previous starting image is not again selected. In FIG. 21, the images of interest are images I₅, I₆, I₇, I₈ of which the image I5 having the smallest image number can be selected as the next starting image. Subsequently, the processing procedure starting at the step S43 is repeatedly executed until it is determined at step S45 that all images have been processed. As a result, as illustrated in FIG. 21, the images I₁, I₅, I₁₀, . . . that are surrounded by bold frames are set as representative images.

When it is determined in the step S45 that all images have been processed, the network generator 12 configures a set of images on a higher i-th order layer with the representative images (step S47), and associates a pair of images with one another, of the representative images, which have the display link distances of “2” on the (i−1)th layer, to set all the display link distances between the associated images to “1” (step S48). As a result, a network of the i-th order layer is built. In an example shown in FIG. 22, links C_{1,5}, C_{1,6}, C_{1,7}, . . . are formed among the representative images surrounded by the bold frames shown in FIG. 21.

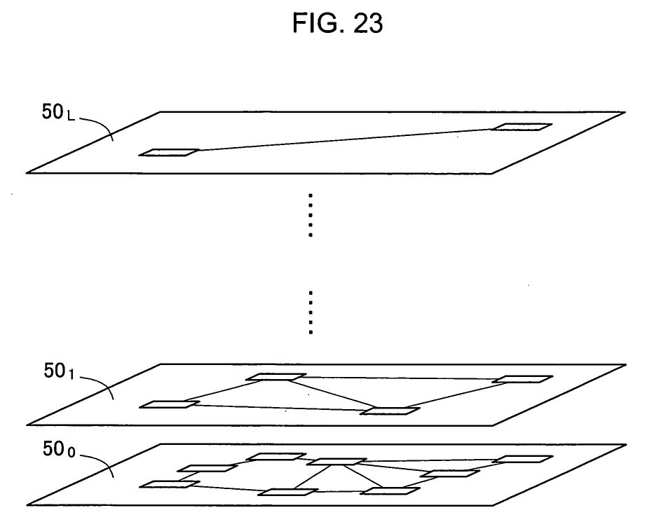

Next, the network generator 12 determines whether or not the layering processing procedure should be terminated (step S49). When determining that the layered processing procedure should not be terminated, the network generator 12 increments the layer number i (step S50), and repeatedly executes the processing procedure starting at the step S42. On the other hand, when determining that the layering processing procedure should be terminated, the network generator 12 terminates the layering processing procedure, and records the built first-order to L-th order layers (where L is an integer equal to or larger than one) in the network database 20. As a result, networks 50₀ to 50_{L} of the zero-th order to L-th order layers are built, as shown in FIG. 23.

At the step S44, the processing is executed to delete neighboring images which are next to the representative image. Instead of this, images which have the display link distances equal to or smaller than N from the representative image (where N is an integer equal to or larger than two) may be deleted.

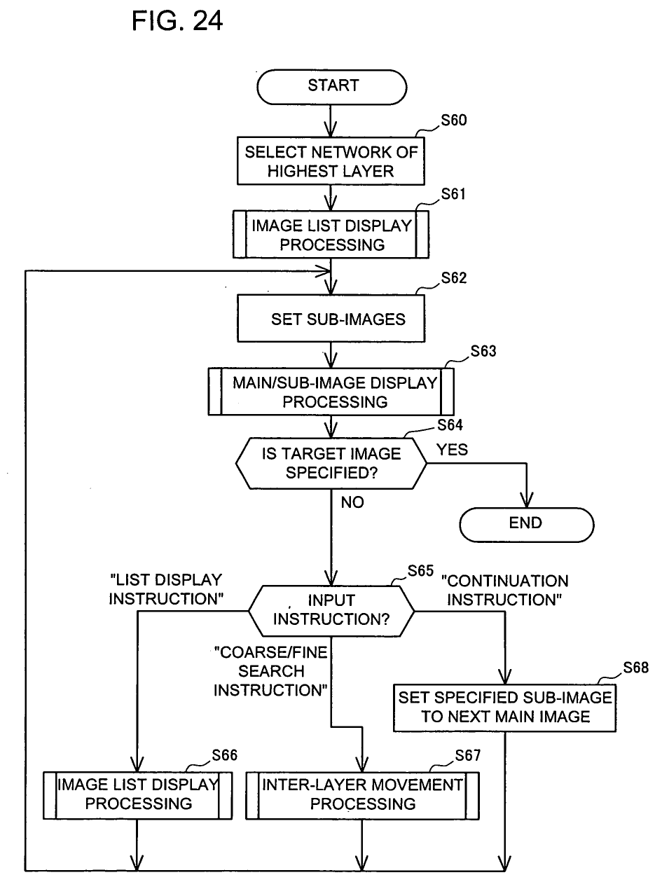

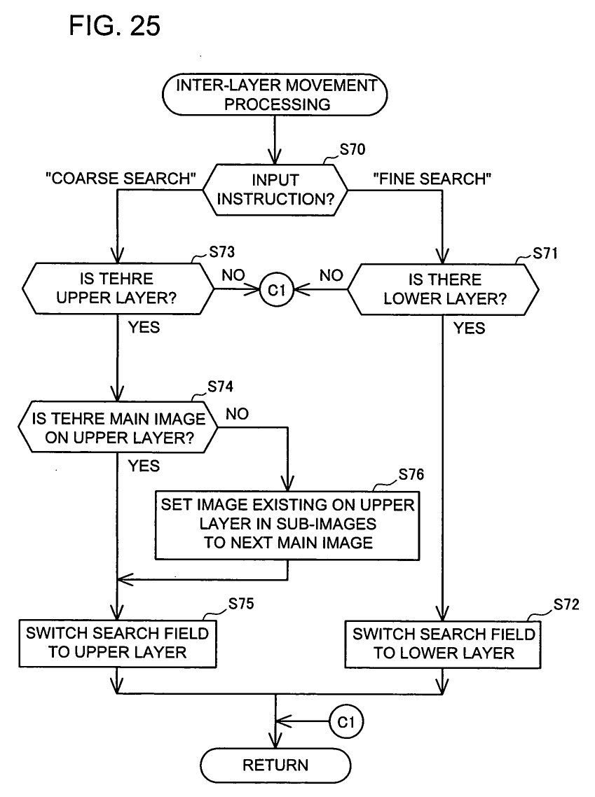

Next, image search processing using the layered network will be described with reference to FIGS. 24 and 25. FIG. 24 is a flow chart schematically showing a procedure of the image search processing to be performed by the main controller 13.

First, at step S60, the layer selector 13A (FIG. 1) selects, as a field to be searched, the network of the highest L-th order layer is selected from the networks at the zero-th order to L-th order layers stored in the network database 20. Alternatively, a first field to be searched may be selected by the user through the operating device 16.

Next, the display controller 13C executes the list display processing shown in FIG. 11 to display images to be searched belonging to the highest layer in a list on the display device 18 (step S61). Specifically, the main image and sub-images belonging to the highest layer are displayed in a list on the screen 40 of the display device 18, as shown in FIG. 12. The user, when finding a target image, can specify the target image by manipulating the operating device 16 for input. In such an event, this search processing procedure is terminated (step S33 in FIG. 11). When the user cannot find a target image, the user can specify an image other than the target image as the next main image. In such an event, the specified image is set to the main image (step S34 in FIG. 11).

At next step S62, the image selector 13B sets, as sub-images, images which have the display link distances equal to or smaller than the set value Rs from the main image (step S62). Subsequently, the display controller 13C displays the main image and sub-images in a list on the display device 18 (step S63). The user can specify a desired target image from the images displayed on the screen 40 by manipulating the operating device 16 for input. The image selector 13B detects an input instruction from the operating device 16, thereby determining whether or not a target image is specified (step S64). When the user specifies a target image, the image selector 13B determines that the target image is specified, and terminates the image search processing procedure.

On the other hand, when the user does not specify a target image but inputs another instruction, the image selector 13B determines that no target image is specified (step S64), and subsequently, the processing procedure proceeds to either step S66, S67, or S68 in accordance with the type of an input instruction. When the input instruction is a “list display instruction,” the list display processing (FIG. 11) at step S66 is executed, and subsequently, the processing procedure starting at step S62 is repeatedly executed. On the other hand, when the user inputs an instruction for changing one of the sub-image to a main image, the image selector 13B determines that there is a “continuation instruction” indicating that the search is continued on the current layer (step S65), and sets the specified sub-image to the next main image (step S68). Subsequently, the processing procedure starting at step S62 is repeatedly executed.

On the other hand, when the input instruction is a “coarse/fine search instruction,” inter-layer movement processing at step S67 is executed. In the following, a procedure of the inter-layer movement processing to be performed by the layer selector 13A will be described with reference to a flow chart of FIG. 25. A reference symbol C1 in the figure represents a connector.

First, the layer selector 13A determines whether an instruction input by the user is a “coarse search” or a “fine search” (step S70). When there is the input instruction of “fine search,” it is determined whether or not a network exists on a layer lower than the current layer (step S71). If no lower layer exists, the processing procedure proceeds to the main routine (FIG. 24), and the processing procedure starting at step S62 is repeatedly executed.

On the other hand, if it is determined in the step S71 that the lower layer exists, the layer selector 13A switches the field to be searched from the current layer 50ₖ₊₁ (where k is an integer equal to or larger than zero) to a lower layer 50ₖ (step S72), and returns the procedure to the main routine (FIG. 24). Subsequently, the processing procedure starting at step S62 is repeatedly executed. As a result, the main image and sub-images belonging to the lower layer 50ₖ are displayed on the display screen 40 of the operating device 16, so that the user can search for a target image which may exist on the lower layer 50ₖ while viewing the display screen 40.

When the input instruction is determined to be “coarse search” at step S70, the layer selector 13A determines whether or not a network exists on a layer higher than the current layer (step S73). When no higher layer exists, the processing procedure proceeds to the main routine (FIG. 24), and the processing procedure starting at step S62 is repeatedly executed.

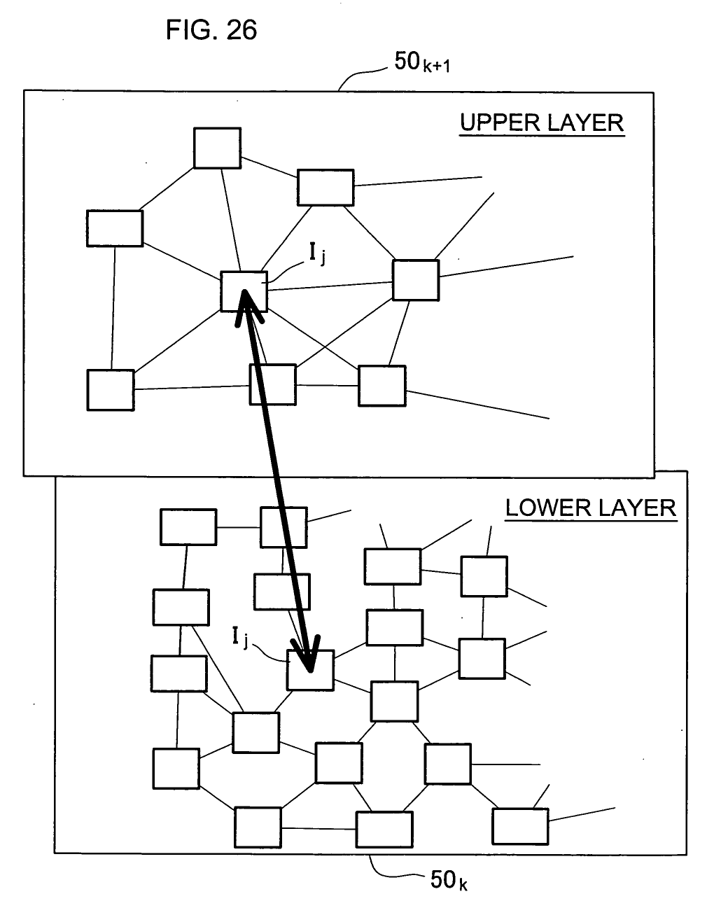

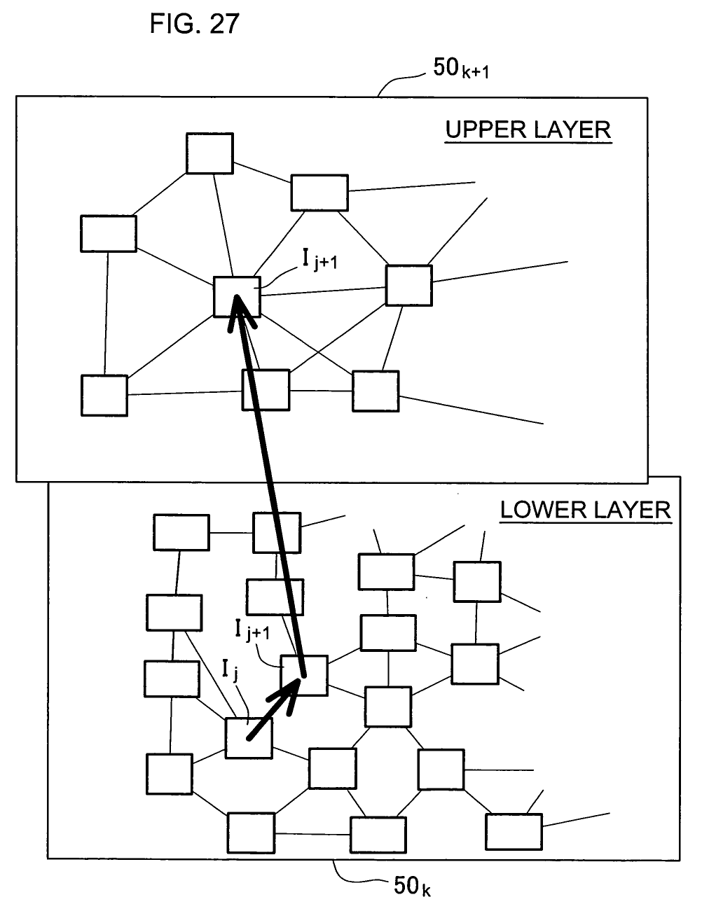

On the other hand, when it is determined in the step S73 that the higher layer exists, the layer selector 13A determines whether or not a main image exists on a higher layer 50ₖ₊₁ (step S74). As illustrated in FIG. 26, when main images Iⱼ exist on the current and higher layers 50ₖ and 50ₖ₊₁, the layer selector 13A switches the field to be searched from the current layer 50ₖ to the higher layer 50ₖ₊₁ (step S75), and subsequently moves the procedure to the main routine (FIG. 24). On the other hand, when the main image Iⱼ existing on the current layer 50ₖ does not exist on the higher layer 50ₖ₊₁, as illustrated in FIG. 27, the layer selector 13A sets one of sub-images Iⱼ₊₁ which have the shortest display link distance from the main image Iⱼ, i.e., one of those images which are next to the main image Iⱼ and exist on the higher layer as well is set to the next main image (step S75), and subsequently, the processing procedure returns to the main routine (FIG. 24). Subsequently, the processing procedure starting step S62 is repeatedly executed. As a result, the main image and sub-images belonging to the higher layer 50ₖ₊₁ are displayed on the display screen 40 of the operating device 16, so that the user can search for a target image which may exist on the higher layer 50ₖ₊₁ while viewing the display screen 40.

In this way, the user can efficiently and conveniently search for a desired target image while moving between layers. Also, since the image search processing mainly uses only the layer information and link information in the database, the search can be made at high speed with less calculation and without complicated procedure.

In the foregoing, the image search apparatus of embodiments according to the present invention have been described. In the above embodiments, the topology of the network shown in FIG. 6 is not displayed on the display device 18. The topology may nevertheless be displayed in three-dimensions on the display device 18 when the user searches for a target image or specifies a main image.

The present application is based on Japanese Patent Application No. 2004-106037 which is hereby incorporated by reference.

1. An image search method comprising the steps of:
(a) extracting at least one component from each of a plurality of images to be searched, said at least one component being common to the plurality of images to be searched;
(b) deriving a feature which characterizes each of the images to be searched based on said at least one component;
(c) calculating similarity measures among the plurality of images to be searched using the feature, and associating images that have the similarity measures within a predetermined range, with one another through links; and
(d) calculating a display link distance between two images to be searched that are associated with each other through N links (where N is an integer equal to or larger than one), so as to set the display link distance between the two images to N, and searching the plurality of images.

2. An image search method according to claim 1, wherein the display link distance is set to a number of links on a shortest path of paths extending from one image to the other image of the two images to be searched that are associated through N links.

3. An image search method according to claim 2, wherein said step (d) includes the steps of:
(e) setting at least one of the plurality of images to be searched to a main image, and setting the images except for the main image to sub-images; and
(f) displaying, on the same screen, the main image and the sub-images having the respective display link distances within a set range after performing said step (e).

4. An image search method comprising the steps of:
(a) extracting at least one component from each of a plurality of images to be searched, said at least one component being common to the plurality of images to be searched;
(b) deriving a feature which characterizes each of the images to be searched based on said at least one component;
(c) calculating similarity measures among the plurality of images to be searched using the feature, and associating images that have the similarity measures within a predetermined range, with one another through links;
(d) generating a lower layer constituted by the images to be searched that are associated with one another in said step (c);
(e) extracting, from the lower layer, images that are associated with one another through M links (where M is an integer equal to or larger than two), and setting images to be searched that constitute an upper layer higher than the lower layer by the extracted images;
(f) in the upper layer, associating images that have the respective similarity measures within a predetermined range among the images to be searched, with one another through links; and
(g) calculating a display link distance between two images to be searched that are associated with each other through N links (where N is an integer equal to or larger than one), so as to set the display link distance between the two images to N, and searching the plurality of images,
wherein said steps (e) and (f) are recursively performed to generate a plurality of layers.

5. An image search method according to claim 4, wherein the display link distance is a number of links on a shortest path of paths extending from one image to the other image of the two images to be searched that are associated through N links.

6. An image search method according to claim 5, wherein said step (g) further comprises the steps of:
(h) selecting one layer from the layers as a search field;
(i) setting, to a main image, at least one image of a plurality of images to be searched that constitute the layer selected in said step (h), and setting the images except for the main image to sub-images; and
(j) displaying, on the same screen, the main image and the sub-images having the display link distances within a set range after performing said step (i).

7. An image search method according to any one of claims 4 to 6, further comprising the steps of:
(k) switching a search field from a lower layer to an upper layer;
(m) when the main image does not exist in the upper layer, setting, to a next main image, an image to be searched that has the shortest display link distances from the main image in the lower layer and exists in the upper layer; and
(n) after performing said steps (k) and (m), displaying, on the same screen, the main image and the sub-images having the display link distances within a set range.

8. An image search method according to any one of claims 4 to 7, further comprising the steps of:
(o) switching a search field from an upper layer to a lower layer; and
(p) after performing said step (o), displaying, on the same screen, the main image and the sub-images having the display link distances within a set range in the lower layer.

9. An image search method according to any one of claims 1 to 8, wherein:
said step (b) includes calculating a plurality of feature values which characterize each of the images to be searched on the basis of said at least one component, and storing a set of the plurality of feature values as a vector in a metric space of the images to be searched; and
said step (c) includes calculating distances between the images to be searched as the respective similarity measures by using the vectors as the features.

10. An image search method according to claim 9, wherein said distances are Euclidean distances.

11. An image search method according to claim 9, wherein:
the images to be searched are still images; and
said step (b) includes dividing each of the still images into a plurality of blocks, and calculating the plurality of feature values for each of the blocks on the basis of a plurality of components extracted from each of the blocks.

12. An image search method according to claim 11, wherein the plurality of components is comprised of a set of color components that constitute each pixel, and the feature value is an average value of the set of color components in each of the blocks.

13. An image search method according to claim 9, wherein:
the images to be searched are moving images comprised of a plurality of sequential frames; and
said step (b) includes dividing each of the sequential frames into a plurality of blocks, and calculating the plurality of feature values on the basis of a plurality of components extracted from each of the blocks.

14. An image search method according to claim 13, wherein:
the plurality of components is comprised of a set of color components which constitute each pixel; and
the feature value is a value obtained by averaging average values of the set of color components in each of the blocks over the plurality of sequential frames.

15. An image search method according to any one of claims 1 to 8, wherein said step (a) includes extracting meta data from each of the image to be searched as the component.

16. An image search method according to claim 15, wherein said step (c) includes calculating a value proportional or reciprocally proportional to a matching rate of the meta data between the images to be searched as the similarity measure by using the meta data as the feature.

17. An image search apparatus comprising:
a storage device for accumulating a plurality of images to be searched;
a feature acquisition unit for extracting at least one component from each of the plurality of images to be searched, said at least one component being common to the plurality of images to be searched, and for deriving a feature which characterizes each of the images to be searched based on said at least one component;
a network generator for calculating similarity measures among the plurality of images to be searched using the feature, and associating images that have the similarity measures within a predetermined range, with one another through links; and
an image search unit for calculating a display link distance between two images to be searched that are associated with each other through N links (where N is an integer equal to or larger than one), so as to set the display link distance between the two images to N, and searching the plurality of images.

18. An image search apparatus according to claim 17, wherein the display link distance is set to a number of links on a shortest path of paths extending from one image to the other image of the two images to be searched that are associated through N links.

19. An image search apparatus according to claim 18, wherein said image search unit includes:
an image selector for setting at least one of the plurality of images to be searched to a main image, and setting the images except for the main image to sub-images; and
a display controller for displaying, on the same screen, the main image and the sub-images having the respective display link distances within a set range after the setting for the main image and the sub-images.

20. An image search apparatus comprising:
a storage device for accumulating a plurality of images to be searched;
a feature acquisition unit for extracting at least one component from each of the plurality of images to be searched, said at least one component being common to the plurality of images to be searched, and for deriving a feature which characterizes each of the images to be searched based on said at least one component;
a network generator for calculating similarity measures among the plurality of images to be searched using the feature, and associating images that have the similarity measures within a predetermined range, with one another through links, and for generating a lower layer constituted by the associated images to be searched; and
an image search unit for calculating a display link distance between two images to be searched that are associated with each other through N links (where N is an integer equal to or larger than one), so as to set the display link distance between the two images to N, and searching the plurality of images;
wherein said network generator generates a plurality of layers by recursively performing the processes of: extracting, from the lower layer, images that are associated with one another through M links (where M is an integer equal to or larger than two); setting images to be searched that constitute an upper layer higher than the lower layer by the extracted images; and in the upper layer, associating images that have the respective similarity measures within a predetermined range among the images to be searched, with one another through links.

21. An image search apparatus according to claim 20, wherein the display link distance is a number of links on a shortest path of paths extending from one image to the other image of the two images to be searched that are associated through N links.

22. An image search apparatus according to claim 21, wherein said image search unit includes:
an image selector for selecting one layer from the layers as a search field, and for setting, to a main image, at least one image of a plurality of images to be searched that constitute the selected layer, and setting the images except for the main image to sub-images; and
a display controller for displaying, on the same screen, the main image and the sub-images having the display link distances within a set range after the setting for the main image and the sub-images.

23. An image search apparatus according to any one of claims 20 to 22, wherein:
said image search unit further includes a layer selector for switching a search field from a lower layer to an upper layer;
when the main image does not exist in the upper layer, said layer selector switches the search field after setting, to a next main image, an image to be searched that has the shortest display link distances from the main image in the lower layer and exists in the upper layer; and
said display controller displays, on the same screen, the main image and the sub-images having the display link distance within a set range after the switching of the search field by said layer selector.

24. An image search apparatus according to any one of claims 20 to 23, wherein:
said image search unit further includes a layer selector for switching a search field from an upper layer to a lower layer; and
said display controller displays, on the same screen, the main image and the sub-images having the display link distances within a set range after the switching of the search field by said layer selector.

25. An image search apparatus according to any one of claims 17 to 24, wherein:
said feature acquisition unit calculates a plurality of feature values which characterize each of the images to be searched on the basis of the components, and stores a set of the plurality of feature values as a vector in a metric space of the images to be searched; and
said network generator calculates distances between the images to be searched as the respective similarity measures by using the vectors as the features.

26. An image search method according to claim 25, wherein said distances are Euclidean distances.

27. An image search apparatus according to claim 25, wherein:
the images to be searched are still images; and
said feature acquisition unit divides each of the still image into a plurality of blocks, and calculates the plurality of feature values for each of the blocks on the basis of a plurality of components extracted from each of the blocks.

28. An image search method according to claim 27, wherein the plurality of components is comprised of a set of color components that constitute each pixel, and the feature value is an average value of the set of color components in each of the blocks.

29. An image search method according to claim 25, wherein:
the images to be searched are moving images comprised of a plurality of sequential frames; and
said feature acquisition unit divides each of the sequential frames into a plurality of blocks, and calculates the plurality of feature values on the basis of a plurality of components extracted from each of the blocks.

30. An image search method according to claim 29, wherein:
the plurality of components comprises a set of color components that constitute each pixel; and
said feature value is a value obtained by averaging average values of the set of color components in each of the blocks over the plurality of sequential frames.

31. An image search method according to any one of claims 17 to 24, wherein said feature acquisition unit extracts meta data from each of the image to be searched as the component.

32. An image search method according to claim 31, wherein said network generator calculates a value proportional or reciprocally proportional to a matching rate of the meta data between the images to be searched as the similarity measure by using the meta data as the feature.

33. A recording medium having an image search program code thereon, said image search program causing a computer to execute the following processing:
storage processing for accumulating a plurality of images to be searched;
feature acquisition processing for extracting at least one component from each of the plurality of images to be searched, said at least one component being common to the plurality of images to be searched, and for deriving a feature which characterizes each of the images to be searched on the basis of said at least one component;
network generating processing for calculating similarity measures among the plurality of images to be searched using the feature, and for associating images that have the similarity measures within a predetermined range, with one another through links; and
image search processing for calculating a display link distance between two images to be searched that are associated with each other through N links (where N is an integer equal to or larger than one), so as to set the display link distance between the two images to N, and for searching the plurality of images.

34. A recording medium having an image search program code thereon, said image search program causing a computer to perform the following processing:
storage processing for accumulating a plurality of images to be searched;
feature acquisition processing for extracting at least one component from each of the plurality of images to be searched, said at least one component being common to the plurality of images to be searched, and for deriving a feature which characterizes each of the images to be searched based on said at least one component;
lower layer generating processing for calculating similarity measures among the plurality of images to be searched using the feature, and associating images that have the similarity measures within a predetermined range, with one another through links, and for generating a lower layer constituted by the associated images to be searched; and
image search processing for calculating a display link distance between two images to be searched that are associated with each other through N links (where N is an integer equal to or larger than one), so as to set the display link distance between the two images to N, and searching the plurality of images;
wherein said image search program causing a computer to generates a plurality of layers by recursively performing upper layer generating processing for: extracting, from the lower layer, images that are associated with one another through M links (where M is an integer equal to or larger than two); setting images to be searched that constitute an upper layer higher than the lower layer by the extracted images; and in the upper layer, associating images that have the respective similarity measures within a predetermined range among the images to be searched, with one another through links.
